(19) United States
(12) Patent Application Publication
(10) Pub. No.: US 2014/0118418 A1
(43) Pub. Date: May 1, 2014

(54) DISPLAY PANEL DRIVER AND DRIVING METHOD THEREOF

(71) Applicant: LAPIS Semiconductor Co., Ltd., Yokohama (JP)

(72) Inventors: Hironori KONDO, Yokohama (JP); Atsushi YUSA, Yokohama (JP); Yuichi NAKANISHI, Yokohama (JP)

(73) Assignee: LAPIS SEMICONDUCTOR CO., LTD., Yokohama (JP)

(21) Appl. No.: 14/056,555

(22) Filed: Oct. 17, 2013

(30) Foreign Application Priority Data
Oct. 26, 2012 (JP) 2012-236662

(51) Int. Cl. G09G 5/10; G09G 3/28; G09G 3/32; G09G 3/34

(52) U.S. Cl. CPC G09G 5/10; G09G 3/3406; G09G 3/2803; G09G 3/3208
USPC 345/690; 345/211; 345/212

(57) ABSTRACT

A display panel driver that can take in pixel data without wasteful electric power consumption even if the number of output terminals of the display panel driver is greater than the number of source lines of the display panel, and a driving method thereof. The display panel driver has latches individually, respectively hold pixel data pieces, each of which is for a pixel, based on an input video signal according to information stored in a setting register and applies drive pulses corresponding to the pixel data pieces held in the latches to the source lines of the display panel.

### BACKGROUND OF THE INVENTION

1. Field of the Invention

The present invention relates to a display panel driver that drives a display panel according to a video signal and a driving method thereof.

2. Description of the Related Art

Display panels such as plasma display panels, liquid crystal panels, and organic EL (Electro Luminescence) panels are provided with a source driver to supply tone voltages according to a video signal to source lines formed in the display panel (refer to, e.g., FIG. 1 of Japanese Patent Publication No. 3544470). The source driver, in response to a start pulse supplied from a control part, sequentially takes in one display line worth of pixel data indicated in the video signal on a per pixel basis and outputs tone voltages corresponding to the respective taken-in pixel data via output terminals connected to the source lines respectively.

Among the display panels manufactured by makers, there are ones wherein the total number of source lines does not necessarily coincide with the number of output terminals of a source driver. Hence, for example, where a display panel having 1,000 source lines is driven using four source driver ICs (Integrated Circuits) of which the numbers of output terminals are 300, two-hundred (200) ones of the output terminals of the source driver ICs are vacant (refer to, e.g., FIG. 13 of Japanese Patent Publication No. 3544470).

Meanwhile, for such source drivers, there has been proposed a source driver wherein the direction (scan direction) in which pixel data are taken in is switchable (refer to, e.g., Japanese Patent Application Laid-Open No. 2010-281990). For example, of first to 1000th source lines arranged in a display panel, taking in respective pixel data for the source lines can be performed selectively either in ascending order from the first source line or in descending order from the 1000th source line.

In this source driver, if a source driver IC having vacant terminals as described above is contained, in order to allow the source driver to start taking in pixel data with this source driver IC side, the following process is performed. That is, after a start pulse (STH) is supplied, first, respective dummy pixel data for the vacant terminals are sequentially taken in, and then respective actual pixel data for the source lines of the display panel are sequentially taken in (refer to, e.g., FIG. 5 of Japanese Patent Application Laid-Open No. 2010-281990).

Thus, the problem occurs that if starting taking in pixel data with the vacant terminal side, the source driver has to take in dummy data, resulting in electric power being wastefully consumed.

Further, display panels comprise a timing controller to supply pixel data and timing-related signals to the source driver and so on. In recent years, ICs wherein the timing controller and the source driver are integrally formed have begun to be developed (refer to, e.g., Japanese Patent Application Laid-Open No. 2009-32714 or Japanese Patent Application Laid-Open No. 2010-190932).

### SUMMARY OF THE INVENTION

An object of the present invention is to provide a display panel driver that can take in pixel data without wasteful electric power consumption even if the number of output terminals of the display panel driver is greater than the number of source lines of the display panel, and a driving method thereof.

A display panel driver according to the present invention is a display panel driver which applies drive pulses corresponding to pixel data pieces, each of which is for a pixel, based on an input video signal to source lines of a display panel and comprises an enable signal generating part that generates a plurality of enable signals based on information in a setting register; a plurality of latch circuits to which the enable signals are supplied respectively and that hold the pixel data pieces in response to the enable signals being activated supplied thereto; and a drive part that generates and outputs drive pulses respectively corresponding to the pixel data pieces held in the plurality of latch circuits.

A driving method according to the present invention is a display panel driving method which applies drive pulses according to an input video signal to source lines of a display panel by a display panel driver and comprises the steps of the display panel driver storing information designating latch circuits to, in turn, hold pixel data pieces, each of which is for a pixel, based on the input video signal in a setting register; having the latch circuits, which are sequentially activated according to the information in the setting register, store the pixel data pieces respectively; and applying drive pulses based on the pixel data pieces stored in the latch circuits to the source lines.

The display panel driver according to the present invention has the first to kth latches individually, respectively hold one display line worth of pixel data pieces, each of which is for a pixel, based on the input video signal according to the latch enable signals and applies drive pulses corresponding to the pixel data pieces held in the latches to the source lines of the display panel. This display panel driver comprises the setting register that stores the head latch designating data and the scan direction designating data and has the latches take in pixel data pieces according to the head latch designating data and the scan direction designating data as follows. That is, the display panel driver selectively supplies the latch enable signal to the latches in latch-number ascending order or descending order designated by the scan direction designating data, starting with the latch of the latch number designated by the head latch designating data from among the first to kth latches.

Thus, with this configuration, even where the number (k number) of latches respectively corresponding to the output terminals for outputting drive pulses provided in the display panel driver is greater than the number of source lines of the display panel, that is, even where the display panel driver has vacant terminals, taking in pixel data pieces can be started directly with the latch designated by the head latch designating data. Thus, whether the order (direction) in which the first to kth latches take in pixel data pieces is latch-number ascending order or latch-number descending order, the display panel driver does not need to have the latches corresponding to the vacant terminals take in dummy data, and hence it is possible to suppress wasteful electric power consumption.

### BRIEF DESCRIPTION OF THE DRAWINGS

FIG. 1 is a block diagram showing schematically the configuration of a display device including a display panel driver according to the present invention;

FIG. 2 is a block diagram showing the internal configuration of a source driver 13 as a display panel driver according to the present invention;

FIGS. 3A to 3C are diagrams showing examples of the correspondence relation between the scan direction of pixel data and setting data (DL_{H}, DL_{T}, D_{SCN}) stored in a setting data transmitting part 14;

FIG. 4 is a time chart showing an example of the internal operation of the source driver 13 where pixel data are taken in in latch-number ascending order;

FIG. 5 is a time chart showing an example of the internal operation of the source driver 13 where pixel data are taken in in latch-number descending order; and

FIG. 6 is a diagram showing an example of layout for where a drive control part 11 and the source driver 13 are formed on a single chip.

### DETAILED DESCRIPTION OF THE INVENTION

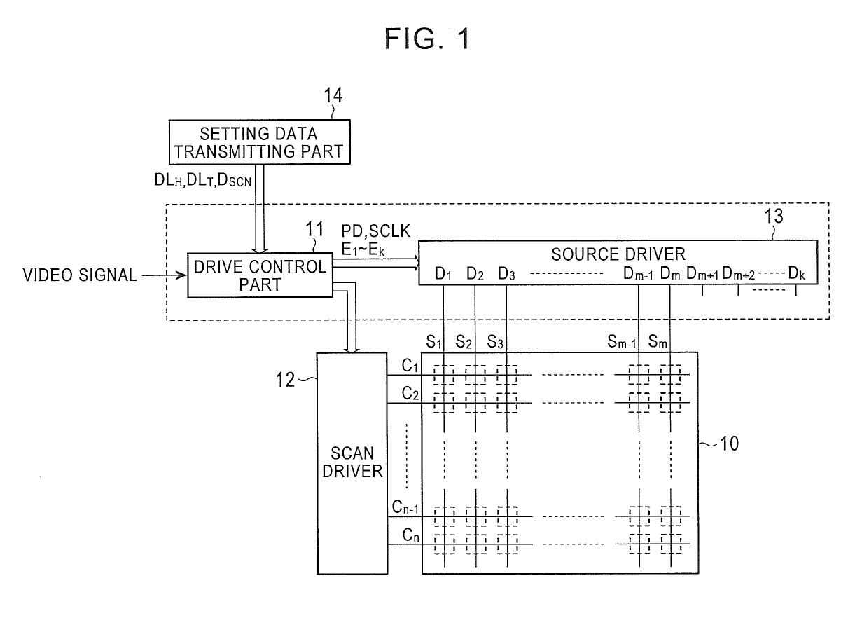

FIG. 1 is a block diagram showing schematically the configuration of a display device including a display panel driver according to the present invention.

As shown in FIG. 1, this display device includes a display panel 10, a drive control part 11, a scan driver 12, a source driver 13, and a setting data transmitting part 14.

The display panel 10 is a display panel for two-dimensional image display constituted by a plasma display panel, a liquid crystal panel, an organic EL panel, or the like. In the display panel 10, there are provided n scan lines C₁ to Cₙ (n is an integer greater than or equal to two) which each extend in a horizontal direction of a two-dimensional screen and m source lines S₁ to Sₘ (m is an integer greater than or equal to two) which each extend in a vertical direction of the two-dimensional screen, and in each of the intersection regions of the scan lines and the source lines (enclosed by broken lines), a display cell for a pixel is formed.

The drive control part 11, in response to an input video signal that represents 2ⁿ tones of brightness in n bits (n is an integer greater than or equal to one), generates a scan control signal for applying a scan pulse sequentially to the scan lines C₁ to Cₙ and supplies this to the scan driver 12. The scan driver 12 generates a scan pulse at a timing according to the scan control signal and applies this scan pulse sequentially, selectively to the scan lines C₁ to Cₙ of the display panel 10.

The drive control part 11 generates a start pulse signal ST at each horizontal synchronization timing based on the input video signal and supplies this to the source driver 13. Further, the drive control part 11 generates pixel data PD representing the brightness level for each pixel based on the input video signal and, in response to the above start pulse signal ST, supplies one display line worth (here m number) of pixel data at a time serially at timings synchronous with a scan clock signal SCLK to the source driver 13. That is, the drive control part 11 generates one display line worth of a series of pixel data PD that is pixel data PD₁, PD₂, PD₂, . . . , PDₘ₋₁, PDₘ based on the input video signal at each start pulse signal ST and supplies these pixel data PD sequentially at edge timings of the scan clock signal SCLK to the source driver 13. The drive control part 11 supplies this scan clock signal SCLK as well to the source driver 13.

The source driver 13 is a display panel driver for display panels of which the number of source lines is k (k is an integer greater than m and greater than or equal to three) and has a data latch part (described later) comprising k latches that take in and hold respective pixel data pieces for pixels individually. The source driver 13 generates tone voltages corresponding to the brightness levels indicated by the respective pixel data pieces held in the latches and generates drive pulses GP having these tone voltages as their peak value. That is, the source driver 13 generates k drive pulses GP₁ to GPₖ corresponding to the respective pixel data pieces held in the k latches. The source driver 13 is provided with output terminals D₁ to Dₖ via which to output drive pulses GP₁ to GPₖ respectively. As shown in FIG. 1, D₁ to Dₘ from among the output terminals D₁ to Dₖ of the source driver 13 are respectively connected to the source lines S₁ to Sₘ of the display panel 10. That is, as shown in FIG. 1, Dₘ₊₁ to Dₖ from among the output terminals D₁ to Dₖ of the source driver 13 are vacant.

Although in the embodiment shown in FIG. 1, for convenience of description, only one source driver 13 is shown, a plurality of source drivers can be used depending on the usage. Where a plurality of source drivers are used, the total number of output terminals D for respectively outputting drive pulses GP of all the source drivers corresponds to the above k number.

The setting data transmitting part 14 is constituted by, e.g., a nonvolatile memory such as an EEPROM (Electrically Erasable Programmable Read-Only Memory), a processor, or the like. Where the setting data transmitting part 14 is a nonvolatile memory, head latch designating data DL_{H}, tail latch designating data DL_{T}, and scan direction designating data D_{SCN} are stored beforehand, as setting data for initially setting the source driver 13, in the setting data transmitting part 14. In contrast, where the setting data transmitting part 14 is a processor, the setting data transmitting part 14 outputs results of computing based on other information. The head latch designating data DL_{H} is data indicating the number of the latch, in the data latch part incorporated in the source driver 13, to take in the pixel data piece at the head of the display line. The tail latch designating data DL_{T} is data indicating the number of the latch, in the data latch part, to take in the pixel data piece at the tail of the display line. The scan direction designating data D_{SCN} is data designating in which scan direction to sequentially select latches in the data latch part to take in a pixel data piece, either in latch-number ascending order or in latch-number descending order. For example, if having latches in the data latch part take in a pixel data piece in latch-number ascending order, the scan direction designating data D_{SCN} having a logic level of zero is stored beforehand in the setting data transmitting part 14, and if having latches take in a pixel data piece in latch-number descending order, the scan direction designating data D_{SCN} having a logic level of one is stored.

The setting data transmitting part 14, at initial setting upon power on, transmits the head latch designating data DL_{H}, the tail latch designating data DL_{T}, and the scan direction designating data D_{SCN} to the drive control part 11.

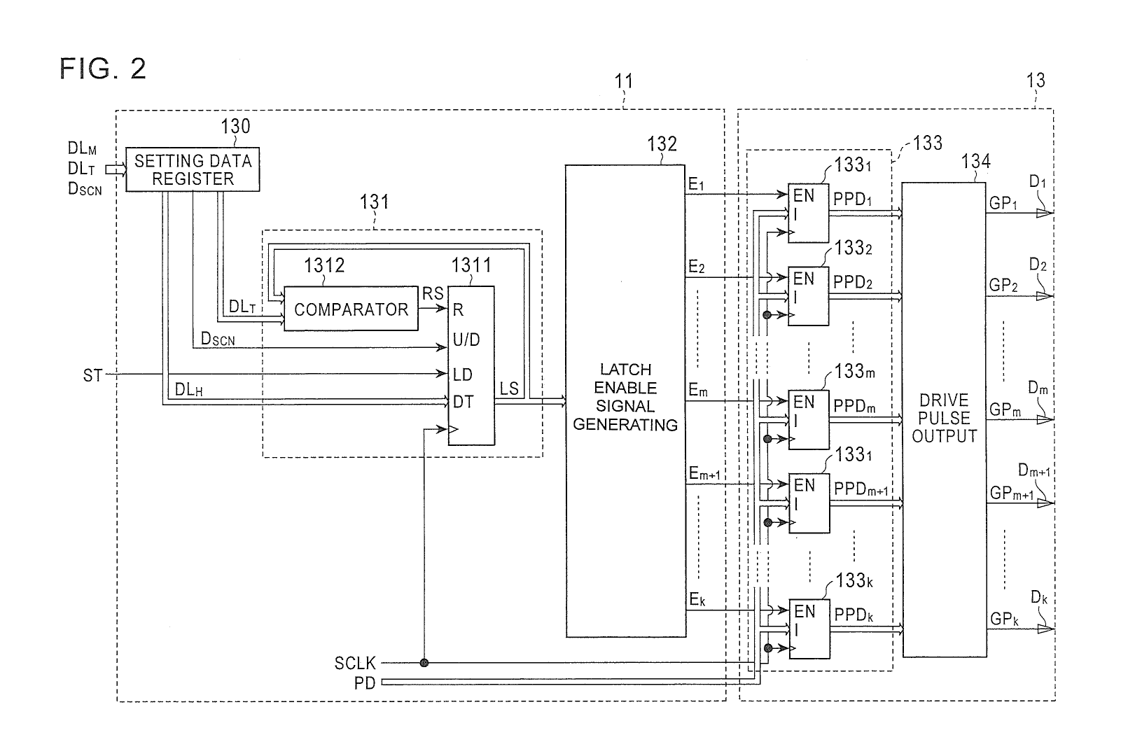

FIG. 2 is a block diagram showing partially the internal configurations of the drive control part 11 and the source driver 13.

As shown in FIG. 2, the drive control part 11 comprises a setting data register 130, a latch selecting counter 131, and a latch enable signal generating part 132. The source driver 13 comprises a data latch part 133 and a drive pulse output part 134.

The setting data register 130 stores at least one data from among the head latch designating data DL_{H}, the tail latch designating data DL_{T}, and the scan direction designating data D_{SCN} supplied from the setting data transmitting part 14 at initial setting upon power on and supplies these data to the latch selecting counter 131. That is, setting data including the head latch designating data DL_{H} and/or the tail latch designating data DL_{T}, the scan direction designating data D_{SCN}, and the like is stored in the setting data register 130 upon power on. Note that if the source driver 13 is configured to be able to store setting data, the setting data transmitting part 14 may be omitted.

The latch selecting counter 131 comprises an up/down counter 1311 and a comparator 1312.

The up/down counter 1311, in response to the start pulse signal ST, takes in the latch number indicated by the head latch designating data DL_{H} as a count initial value. If the scan direction designating data D_{SCN} designates the latch-number ascending order, the up/down counter 1311 operates as an up counter and counts up at each pulse of the scan clock signal SCLK starting from the above count initial value. In contrast, if the scan direction designating data D_{SCN} designates the latch-number descending order, the up/down counter 1311 operates as a down counter and counts down at each pulse of the scan clock signal SCLK starting from the above count initial value. The up/down counter 1311 supplies the current count value as a latch selection value LS to the comparator 1312. The comparator 1312 takes in the latch number indicated by the tail latch designating data DL_{T} as a count end value and, only when the count end value and the latch selection value LS are equal, generates a reset signal RS to reset the count value to zero and supplies this to the up/down counter 1311. In response to this reset signal RS, the up/down counter 1311 resets the current count value to zero and stops counting.

As such, the up/down counter 1311 first takes in the latch number indicated by the head latch designating data DL_{H} as a count initial value in response to the start pulse signal ST. Then, the up/down counter 1311 supplies the count value, which is obtained by counting up or down from the count initial value depending on the scan direction designating data D_{SCN}, as the latch selection value LS to the latch enable signal generating part 132 at the next stage.

The latch enable signal generating part 132 is constituted by a decoder which generates latch enable signals E₁ to Eₖ of which only one is active, that is, has a logic level 1 indicating latch enable while the others have a logic level 0 indicating latch disable, based on the latch selection value LS.

For example, the latch enable signal generating part 132, when the latch selection value LS indicates latch number 1, generates latch enable signals E₁ to Eₖ of which only E₁ has a logic level 1 indicating being active while the others all have a logic level 0. When the latch selection value LS indicates latch number 2, the latch enable signal generating part 132 generates latch enable signals E₁ to Eₖ of which only E₂ has a logic level 1 indicating being active while the others all have a logic level 0. When the latch selection value LS indicates latch number 3, the latch enable signal generating part 132 generates latch enable signals E₁ to Eₖ of which only E₃ has a logic level 1 indicating being active while the others all have a logic level 0. When the latch selection value LS indicates latch number m, the latch enable signal generating part 132 generates latch enable signals E₁ to Eₖ of which only Eₘ has a logic level 1 indicating being active while the others all have a logic level 0. When the latch selection value LS indicates latch number k, the latch enable signal generating part 132 generates latch enable signals E₁ to Eₖ of which only Eₖ has a logic level 1 indicating being active while the others all have a logic level 0.

The latch enable signal generating part 132 supplies the above latch enable signals E₁ to Eₖ to the data latch part 133.

The data latch part 133 comprises k latches 133₁ to 133ₖ, to which latch numbers of 1 to k are assigned respectively, and the above latch enable signals E₁ to Eₖ are supplied to their enable terminals EN respectively. Each of the latches 133₁ to 133ₖ includes n latch elements, n being equal to the number of bits of a pixel data piece. Further, the above pixel data PD is supplied in common to the respective data input terminals I of the latches 133₁ to 133ₖ, and the above scan clock signal SCLK is supplied in common to the respective clock input terminals of the latches 133₁ to 133ₖ. Of the latches 133₁ to 133ₖ, only one latch 133 to whose enable terminal EN is supplied the latch enable signal E having a logic level 1, takes in the pixel data PD in response to the scan clock signal SCLK and holds this.

With this configuration, the latches 133₁ to 133ₖ take in the pixel data PD supplied from the drive control part 11 individually according to the latch enable signals E₁ to Eₖ supplied from the latch enable signal generating part 132 and hold this. And the latches 133₁ to 133ₖ supply pixel data held in themselves as pixel data PPD₁ to PPDₖ to the drive pulse output part 134.

Although in the embodiment shown in FIG. 2 an equal number of latches 133₁ to 133ₖ to the k latch enable signals E are provided, the number of latch enable signals E may not necessarily coincide with the number of latches. For example, it may be configured such that according to the logic level 1 indicating the latch enable signal E₁ being active, a plurality of latches take in data simultaneously. In this case, as to supply lines for supplying the pixel data PD to the data latch part 133, an equal number of supply lines to the number of bits corresponding to the number of data to be taken in simultaneously are needed. The pixel data PD consists of multiple bits for tone voltages. For example, if the number of output terminals D of the source driver 13 is 960, and the tones are represented in eight bits, and the number of channels (data) to be taken in simultaneously is six, then the number of latch enable signals E to be placed between the drive control part 11 and the source driver 13 is 960/6, that is, 160, and the number of supply lines for supplying the pixel data PD is 6×8, for 6×8 bits, and thus at least 48 supply lines are to be placed between the drive control part 11 and the source driver 13. To sum up, one latch enable signal E is connected in common to J (J<k) number of latches 133.

The drive pulse output part 134 comprises k drive elements (not shown) to convert the pixel data PPD₁ to PPDₖ individually to drive pulses GP having the peak voltage corresponding to the brightness level indicated by the pixel data PPD and outputs drive pulses GP₁ to GPₖ respectively corresponding to the pixel data PPD₁ to PPDₖ via output terminals D₁ to Dₖ respectively. That is, the drive pulse output part 134 comprises k output sections each consisting of the above drive element and the output terminal D. Each pixel data PPD represents a brightness tone in n bits, and where one latch enable signal E is supplied to J (J<k) output sections, the number of enable signal lines to be placed is at least k/J. In this case, since a single latch 133 consists of n latch elements, each latch enable signal is to be connected in common to at least n×J latch elements.

The operation of the above source driver 13 will be described below.

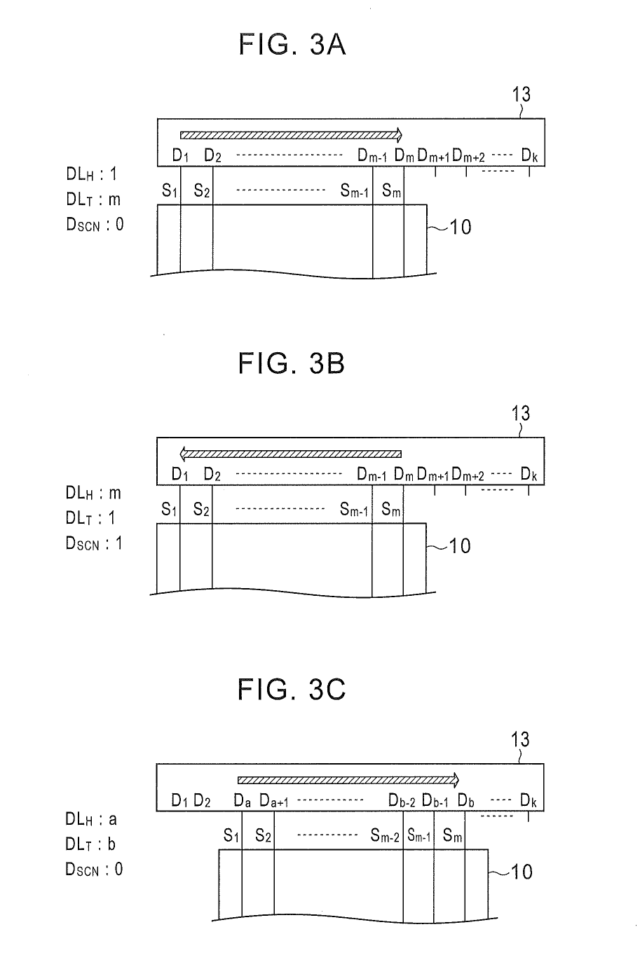

First, where the drive control part 11 has the latches 133₁ to 133ₘ corresponding to the output terminals D₁ to Dₘ of the source driver 13, in turn, take in pixel data in latch-number ascending order, that is, in the order of latches 133₁, 133₂, 133₃, . . . , 133ₘ₋₁, 133ₘ as indicated by an arrow direction in FIG. 3A, the head latch designating data DL_{H}, the tail latch designating data DL_{T}, and the scan direction designating data D_{SCN} as follows, are written beforehand in the setting data transmitting part 14.

DL_{H}: 1

DL_{T}: m

D_{SCN}: 0

That is, the head latch designating data DL_{H} indicating latch number 1 of the latch to take in the head pixel data piece of the display line and the tail latch designating data DL_{T} indicating latch number m of the latch to take in the tail pixel data piece of the display line are written beforehand in the setting data transmitting part 14. Further, the scan direction designating data D_{SCN} SCN having a logic level 0 that designates taking in pixel data pieces in latch-number ascending order is written beforehand in the setting data transmitting part 14.

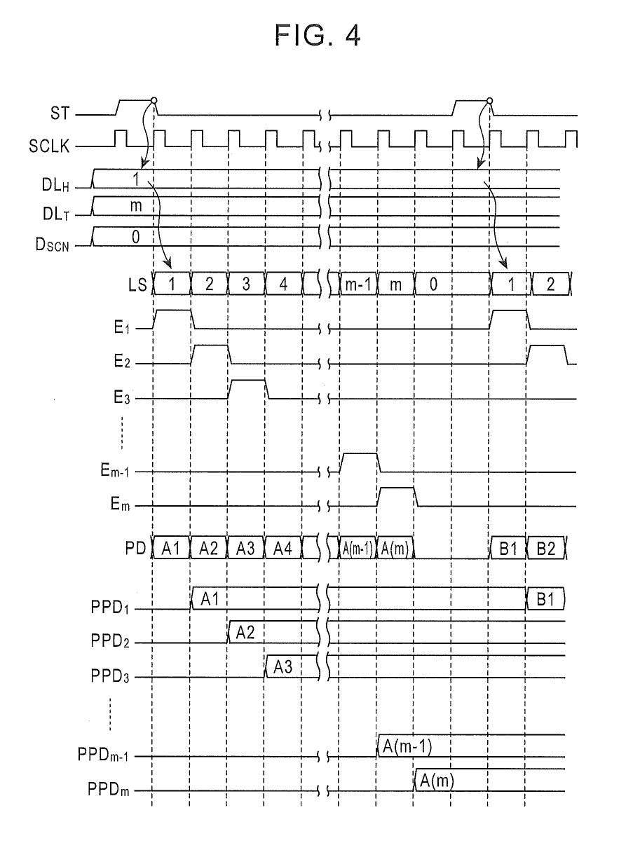

Accordingly, as shown in FIG. 4, the up/down counter 1311 takes in the value of 1 indicated by the head latch designating data DL_{H} as a count initial value in response to the start pulse signal ST and supplies the value as the latch selection value LS to the latch enable signal generating part 132. The latch enable signal generating part 132 first supplies the latch enable signal E₁ having a logic level 1 to latch 133₁ according to the value of 1 indicated by the latch selection value LS as shown in FIG. 4. Thus, the latch 133₁ takes in the value of the pixel data PD and outputs this as the pixel data PPD₁. Since the scan direction designating data D_{SCN} is zero, the up/down counter 1311 operates as an up counter. Hence, the count value of the up/down counter 1311, that is, the latch selection value LS increases by one at each rising edge of the scan clock signal SCLK as shown in FIG. 4. Thus, the latch enable signal generating part 132 supplies the latch enable signals E₂, E₃, . . . , Eₘ₋₁, Eₘ, which, in turn, take on a logic level 1 according to the latch selection value LS as shown in FIG. 4, to the latches 133₂, 133₃, 133₄, . . . , 133ₘ₋₁, 133ₘ. Thus, the latches 133₂ to 133ₘ, in turn, take in values of the pixel data PD at the timings of the latch enable signals E₂ to Eₘ supplied thereto as shown in FIG. 4 and output the values as the pixel data PPD₂ to PPDₘ respectively. When the count value of the up/down counter 1311 becomes equal to the value of m indicated by the tail latch designating data DL_{T}, the comparator 1312 generates the reset signal RS to reset the count value of the up/down counter 1311, that is, the latch selection value LS to zero. Thus, after the latch enable signal Eₘ having a logic level 1 is supplied to the latch 133ₘ, the latch enable signals Eₘ₊₁ to Eₖ having a logic level 1 are not generated, and hence the latches 133ₘ₋₁ to 133ₖ do not take in data. Thereafter, when the start pulse signal ST is supplied, the up/down counter 1311 again takes in the value of 1 indicated by the head latch designating data DL_{H}, and the above operation is repeated.

As such, in the connection state shown in FIG. 1, Dₘ₊₁ to Dₖ of the output terminals D₁ to Dₖ of the source driver 13 are vacant. When pixel data are taken in in latch-number ascending order as shown in FIG. 3A, in the source driver 13, only the latches 133₁ to 133ₘ take in pixel data with the latches 133ₘ₊₁ to 133ₖ corresponding to these vacant terminals Dₘ₊₁ to Dₖ being fixedly disabled.

Next, where the drive control part 11 has the latches 133₁ to 133ₘ corresponding to the output terminals D₁ to Dₘ of the source driver 13, in turn, take in pixel data in latch-number descending order, that is, in the order of latches 133ₘ, 133ₘ₋₁, . . . , 133₃, 133₂, 133₁ as indicated by an arrow direction in FIG. 3B, the head latch designating data DL_{H}, the tail latch designating data DL_{T}, and the scan direction designating data D_{SCN} as follows, are written beforehand in the setting data transmitting part 14.

DL_{H}: m

DL_{T}: 1

D_{SCN}: 1

That is, the head latch designating data DL_{H} indicating latch number m of the latch to take in the head pixel data piece of the display line and the tail latch designating data DL_{T} indicating latch number 1 of the latch to take in the tail pixel data piece of the display line are written beforehand in the setting data transmitting part 14. Further, the scan direction designating data D_{SCN} having a logic level 1 that designates taking in pixel data pieces in latch-number descending order is written beforehand in the setting data transmitting part 14.

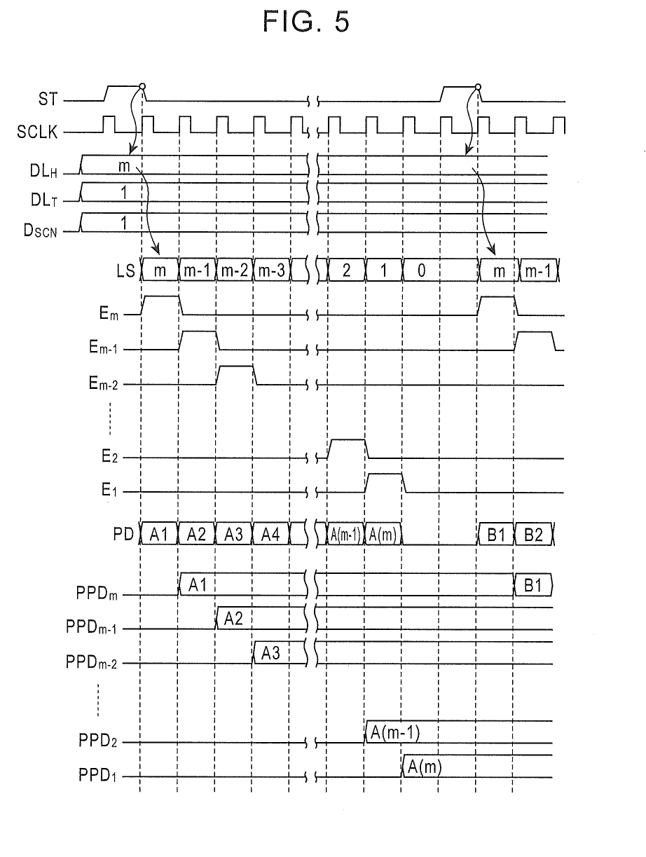

Accordingly, as shown in FIG. 5, the up/down counter 1311 takes in the value of m indicated by the head latch designating data DL_{H} as a count initial value in response to the start pulse signal ST and supplies the value as the latch selection value LS to the latch enable signal generating part 132. The latch enable signal generating part 132 first supplies the latch enable signal Eₘ having a logic level 1 to latch 133ₘ according to the value of m indicated by the latch selection value LS as shown in FIG. 5. Thus, the latch 133ₘ takes in the value of the pixel data PD and outputs this as the pixel data PPDₘ. Since the scan direction designating data D_{SCN} is one, the up/down counter 1311 operates as a down counter. Hence, the count value of the up/down counter 1311, that is, the latch selection value LS decreases by one at each rising edge of the scan clock signal SCLK as shown in FIG. 5. Thus, the latch enable signal generating part 132 supplies the latch enable signals Eₘ, Eₘ₋₁, . . . , E₂, E₁, which, in turn, take on a logic level 1 according to the latch selection value LS as shown in FIG. 5, to the latches 133ₘ, 133ₘ₋₁, . . . , 133₂, 133₁. Thus, the latches 133ₘ₋₁ to 133₁, in turn, take in values of the pixel data PD at the timings of the latch enable signals Eₘ₋₁ to E₁ supplied thereto as shown in FIG. 5 and output the values as the pixel data PPDₘ₋₁ to PPD₁ respectively. When the count value of the up/down counter 1311 becomes equal to the value of 1 indicated by the tail latch designating data DL_{T}, the comparator 1312 generates the reset signal RS to reset the count value of the up/down counter 1311, that is, the latch selection value LS to zero. Thereafter, when the start pulse signal ST is supplied, the up/down counter 1311 again takes in the value of m indicated by the head latch designating data DL_{H}, and the above operation is repeated.

Thus, where latches take in pixel data in latch-number descending order as shown in FIG. 3B, the source driver 13 can have latches take in pixel data in latch-number descending order from the latch 133ₘ, without the latches 133ₘ₊₁ to 133ₖ corresponding to the vacant terminals Dₘ₊₁ to Dₖ being involved. Because the latches 133ₘ₊₁ to 133ₖ corresponding to the vacant terminals Dₘ₊₁ to Dₖ are fixedly disabled, taking in data can be started with a latch (Dₘ) positioned in the middle of the latch series of the data latch part 133 without wasteful electric power consumption.

Next, where the drive control part 11 has latches 133ₐ to 133_{b} corresponding to an output terminal Dₐ (a is an integer greater than one) to an output terminal D_{b} (b=a+m−1) of the source driver 13, in turn, take in pixel data in latch-number ascending order, that is, in the order of latches 133ₐ, 133ₐ₊₁, . . . , 133_{b-2}, 133_{b} as indicated by an arrow direction in FIG. 3C, the head latch designating data DL_{H}, the tail latch designating data DL_{T}, and the scan direction designating data D_{SCN} as follows, are written beforehand in the setting data transmitting part 14.

DL_{H}: a

DL_{T}: b

D_{SCN}: 0

That is, the head latch designating data DL_{H} indicating latch number a of the latch to take in the head pixel data piece of the display line and the tail latch designating data DL_{T} indicating latch number b of the latch to take in the tail pixel data piece of the display line are written beforehand in the setting data transmitting part 14. Further, the scan direction designating data D_{SCN} having a logic level 0 that designates taking in pixel data pieces in latch-number ascending order is written beforehand in the setting data transmitting part 14.

Accordingly, the up/down counter 1311 takes in the value of a indicated by the head latch designating data DL_{H} as a count initial value in response to the start pulse signal ST and supplies the value as the latch selection value LS to the latch enable signal generating part 132. The latch enable signal generating part 132 first supplies the latch enable signal Eₐ having a logic level 1 to latch 133ₐ according to the value of a indicated by the latch selection value LS. Thus, the latch 133ₐ takes in the value of the pixel data PD and outputs this as the pixel data PPDₐ. Since the scan direction designating data D_{SCN} is zero, the up/down counter 1311 operates as an up counter. Hence, the count value of the up/down counter 1311, that is, the latch selection value LS increases by one at each rising edge of the scan clock signal SCLK. Thus, the latch enable signal generating part 132 supplies the latch enable signals Eₐ₊₁, Eₐ₊₂, . . . , E_{b-1}, E_{b}, which, in turn, take on a logic level 1 according to the latch selection value LS, to the latches 133ₐ₊₁, 133ₐ₊₂, 133ₐ₊₃, . . . , 133_{b-1}, 133_{b}. Thus, the latches 133ₐ₊₁ to 133_{b}, in turn, take in values of the pixel data PD at the timings of the latch enable signals Eₐ₊₁ to E_{b} supplied thereto and output the values as the pixel data PPDₐ₊₁ to PPD_{b} respectively. When the count value of the up/down counter 1311 becomes equal to the value of b indicated by the tail latch designating data DL_{T}, the comparator 1312 generates the reset signal RS to reset the count value of the up/down counter 1311, that is, the latch selection value LS to zero. Thereafter, when the start pulse signal ST is supplied, the up/down counter 1311 again takes in the value of a indicated by the head latch designating data DL_{H}, and the above operation is repeated. Thus, the latch enable signals E₁ to Eₐ₋₁ and E_{b+1} to Eₖ having a logic level 1 are not generated, and hence the latches 133₁ to 133ₐ₋₁ and 133_{b+1} to 133ₖ of the latches 133₁ to 133ₖ do not take in data.

Thus, where terminals D₁ to Dₐ₋₁ and D_{b+1} to Dₖ at opposite ends of the source driver 13 are vacant as shown in FIG. 3C, latches can take in pixel data in latch-number ascending order from the latch 133ₐ, without the latches 133₁ to 133ₐ₋₁ and 133_{b+1} to 133ₖ corresponding to these vacant terminals being involved. The latches 133₁ to 133ₐ₋₁ and 133_{b+1} to 133ₖ corresponding to the vacant terminals D₁ to Dₐ₋₁ and D_{b+1} to Dₖ are fixedly disabled. Hence, taking in data can be started with a latch (Dₐ) positioned in the middle of the latch series of the data latch part 133 without wasteful electric power consumption.

As such, the display panel driver (13) according to the present invention has the first to kth latches (133₁ to 133ₖ) individually, respectively hold one display line worth of pixel data pieces (PD), each of which is for a pixel, based on the input video signal according to the latch enable signals (E₁ to Eₖ) and applies drive pulses (GP) corresponding to the pixel data pieces held in the latches to the source lines (S) of the display panel (10). This display panel driver comprises the setting register (130) that stores the head latch designating data (DL_{H}) and the scan direction designating data (D_{SCN}) and has the latches take in pixel data pieces according to the head latch designating data and the scan direction designating data as follows. That is, the display panel driver selectively supplies the latch enable signal to the latches in latch-number ascending order or descending order designated by the scan direction designating data, starting with the latch of the latch number designated by the head latch designating data from among the first to kth latches.

To sum up, the display panel driver according to the present invention, first, stores information designating latch circuits to, in turn, hold pixel data pieces, each of which is for a pixel, based on the input video signal in the setting register and then has the latch circuits, which are activated in turn according to the information in the setting register, store the pixel data pieces respectively. Then, it applies drive pulses based on the pixel data pieces stored in the latch circuits to the source lines.

With this configuration, even where the number (k number) of latches respectively corresponding to the output terminals (D₁ to Dₖ) for outputting drive pulses provided in the display panel driver is greater than the number of source lines of the display panel, that is, even where the display panel driver has vacant terminals, taking in pixel data pieces can be started directly with the latch designated by the head latch designating data. Thus, whether the order (direction) in which the first to kth latches take in pixel data pieces is latch-number ascending order or latch-number descending order, the display panel driver does not need to have the latches corresponding to the vacant terminals take in dummy data, and hence it is possible to suppress wasteful electric power consumption.

Although in the above embodiment the setting data (DL_{H}, DL_{T}, D_{SCN}) is reflected (stored) in the setting data register 130 at initial setting upon power on, this may be performed regularly (e.g., every other second) during normal operation. By this regular setting-data reflection, display malfunction due to data corruption in the setting data register 130 due to external noise can be suppressed to a minimum.

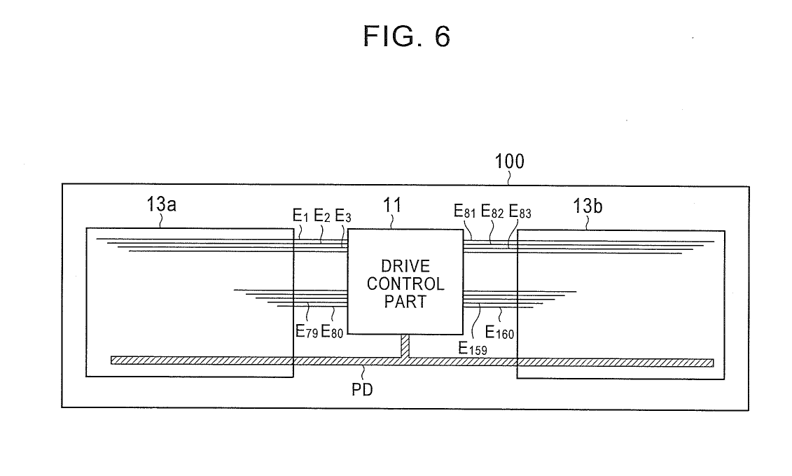

The drive control part 11 and the source driver 13 shown in the area enclosed by a broken line in FIG. 1 are formed on a single semiconductor chip. As described above, with the configuration shown in FIGS. 1 and 2, it is possible to increase the degrees of freedom of the taking-in start position and taking-in end position, but the latch enable signal lines increase in number. Accordingly, if the drive control part 11 and the source driver 13 are configured as separate chips, wires connecting them increase in number, resulting in an increase in package size and restrictions on wiring on the circuit board on which to be mounted. By forming both of them together on a single chip, these restrictions can be reduced to a minimum with increasing the degrees of freedom of the taking-in start position and taking-in end position.

Where the drive control part 11 and the source driver 13 are formed on the same chip, for example, the source driver 13 is divided into source drivers 13a and 13b, and the drive control part 11 is placed to be sandwiched between the source drivers 13a and 13b on a semiconductor chip 100 as shown in FIG. 6. That is, as shown in FIG. 6, the drive control part 11 including the setting data register 130 and the latch enable signal generating part 132 is formed in a timing control area provided in the middle of the semiconductor chip 100. Further, the source driver 13 including the latches 133₁ to 133ₖ and the drive pulse output part 134 is formed in source line drive areas provided on opposite sides of this timing control area. Here, the source driver 13a includes the first one of first and second latch groups into which the latches 133₁ to 133ₖ are separated, and the source driver 13b includes the second latch group. Here, for example, where the first and second latch groups each consist of 80 latches, as shown in FIG. 6, 80 lines for transmitting the latch enable signals E₁ to E₈₀ are placed between the drive control part 11 and the source driver 13a, and 80 lines for transmitting the latch enable signals E₈₁ to E₁₆₀ are placed between the drive control part 11 and the source driver 13b. Thus, a total of 160 lines for the latch enable signals E₁ to E₁₆₀ are dispersed substantially evenly 80 lines each on opposite sides of the drive control part 11, and thus wiring efficiency can be improved.

This application is based on Japanese Patent Application No. 2012-236662 which is herein incorporated by reference.

What is claimed is:

1. A display panel driver which applies drive pulses corresponding to pixel data pieces, each of which is for a pixel, based on an input video signal to source lines of a display panel, said display panel driver comprising:
an enable signal generating part that generates a plurality of enable signals based on information in a setting register;
a plurality of latch circuits to which said enable signals are supplied respectively and that hold said pixel data pieces in response to said enable signals supplied thereto being activated; and
a drive part that generates and outputs drive pulses respectively corresponding to said pixel data pieces held in said plurality of latch circuits.

2. A display panel driver according to claim 1, wherein said setting register stores latch-designating information designating positions of latch circuits with which to start and/or stop holding said pixel data pieces from among said plurality of latch circuits.

3. A display panel driver according to claim 1, wherein said setting register stores information indicating order in which to activate said enable signals.

4. A display panel driver according to claim 1, wherein said enable signal generating part has a counter circuit and activates one of said enable signals corresponding to the count value of said counter circuit.

5. A display panel driver according to claim 4, wherein said enable signal generating part selectively activates one of said enable signals for each count value.

6. A display panel driver according to claim 3, wherein said enable signal generating part has a counter circuit constituted by an up/down counter and has said counter circuit count up or down depending on the information stored in said setting register that indicates order in which to activate said enable signals.

7. A display panel driver according to claim 4, wherein said counter circuit has a count initial value and/or a count end value set based on said latch-designating information stored in said setting register.

8. A display panel driver according to claim 1, wherein said display panel driver can display an input video signal having brightness tones represented in n bits (n is an integer greater than or equal to one), and each of said enable signals is supplied to n latch elements contained in said latch circuit.

9. A display panel driver according to claim 1, wherein said drive part includes k (k is an integer greater than or equal to two) output sections that individually, respectively output k drive pulses respectively corresponding to said pixel data pieces, and
wherein said enable signal generating part activates said enable signals for latch circuits respectively corresponding to L (L≦k) ones of said output sections based on information in said setting register.

10. A display panel driver according to claim 8, wherein said drive part includes k (k is an integer greater than or equal to two) output sections that individually, respectively output k drive pulses respectively corresponding to said pixel data pieces,
wherein if said enable signals are supplied on the basis of J (J<k) ones of said output sections per enable signal, the number of enable signal lines to be placed is at least k/J, and
wherein each of said enable signals is connected in common to at least n×J latch elements.

11. A display panel driver according to claim 1, wherein said setting register, said enable signal generating part, said plurality of latch circuits, and said drive part are formed on a single semiconductor chip,
wherein said setting register and said enable signal generating part are formed in a timing control area on said semiconductor chip, and
wherein said plurality of latch circuits and said drive part are formed in a source line drive area on said semiconductor chip.

12. A display panel driver according to claim 11, wherein said source line drive area is divided into at least two parts between which said timing control area is sandwiched.

13. A display panel driver according to claim 11, wherein the number of enable signal lines wired between said enable signal generating part and said latch circuits is substantially equal for the two divided parts of said source line drive area.

14. A display panel driving method which applies drive pulses according to an input video signal to source lines of a display panel by a display panel driver, comprising the steps of:
said display panel driver storing information designating latch circuits to, in turn, hold pixel data pieces, each of which is for a pixel, based on said input video signal in a setting register;
having the latch circuits, which are sequentially activated according to the information in said setting register, store said pixel data pieces respectively; and
applying drive pulses based on said pixel data pieces stored in said latch circuits to said source lines.

15. A display panel driving method according to claim 14, wherein said step of storing information in said setting register is executed upon power on.

16. A display panel driving method according to claim 14, wherein said step of storing information in said setting register is executed repeatedly at regular timings after power on.
